(19) United States
(12) Patent Application Publication
(10) Pub. No.: US 2018/0034690 A1
(43) Pub. Date: Feb. 1, 2018

(54) System and methods for provisioning devices

(71) Applicant: Hubble Connected India Private Limited, Bangalore (IN)

(72) Inventors: Perumal Raj Sivarajan, Bangalore (IN); Ochintya Sharma, Bangalore (IN); Subramanian Ramakrishnan, Bangalore (IN)

(73) Assignee: Hubble Connected India Private Limited, Bangalore (IN)

(21) Appl. No.: 15/385,704

(22) Filed: Dec. 20, 2016

(30) Foreign Application Priority Data
Jul. 29, 2016 (IN) 201641026128

(51) Int. Cl. H04L 12/24; H04W 76/02; H04W 12/10; H04W 12/04; H04W 12/02; H04L 29/08; H04W 4/00

(52) U.S. Cl. CPC H04L 41/0806; H04L 67/306; H04W 76/023; H04W 4/008; H04W 12/04; H04W 12/02; H04W 12/10

(57) ABSTRACT

System and methods for provisioning devices. Embodiments disclosed herein relate to headless devices, and more particularly to provisioning connectivity for headless devices. Embodiments herein provide methods and systems for provisioning headless devices.

### CROSS REFERENCE TO RELATED APPLICATIONS

This application is based on and derives the benefit of Indian Non Provisional Application 201641026128 filed on 29 Jul. 2016, the contents of which are incorporated herein by reference.

### TECHNICAL FIELD

Embodiments disclosed herein relate to headless devices, and more particularly to provisioning connectivity for headless devices.

### BACKGROUND

Currently, pluralities of devices are available which can use communication protocols (such as Wi-Fi, Bluetooth. ZigBee, NFC (Near Field Communication), and so on) to exchange information and/or instructions with at least one other external entity. Such devices need to be provisioned to enable the communication. However, provisioning on headless devices can be difficult due to the absence of adequate interfaces available on the headless devices, such as displays, keyboards, and so on.

An existing solution uses a key associated with the device and made available to a user of the device, such that the user can use the key to connect to a wireless communication network. This solution relies on public key algorithm (such as Diffie-Hellman or other such as RSA and so on), which may not be optimal for headless devices. In another existing method, a key is typically made available to the user by printing/sticking the key to the device or the package. However, this can result in the key being visible to anyone who can physically access the device. If the key is present on the package, the user will have to preserve the package and/or write down the key in a secure and easy to remember location. Other existing methods use options like infrared or NFC to transmit keys is relatively secure (compared to printing password on package) but it is likely to increase cost of sensor/device.

A current standard approach referred to as WPS (Wi-Fi Protected Setup) is an industry standard for provisioning headless devices and it supports two methods of provisioning. One method used by WPS, Personal Identification Number (PIN), a PIN is printed on a sticker on Access Point (AP). The user reads the PIN and types it using a keypad on the other device. However, this method allows brute force attack to expose the network password within a short span of time. In the WPS Push-Button-Connect (PBC) method, the user pushes button on both the AP and provisioned device. Once the button on AP is pushed. WPS-enabled devices can freely join the network for the period of 2 minutes. However, this method requires the user to have physical access to the AP and there is also a lack of security. Wi-Fi WPS is not considered as secure method.

### OBJECTS

The principal object of embodiments disclosed herein is to provide methods and systems for provisioning headless devices.

### BRIEF DESCRIPTION OF FIGURES

This invention is illustrated in the accompanying drawings, through out which like reference letters indicate corresponding parts in the various figures. The embodiments herein will be better understood from the following description with reference to the drawings, in which:

FIG. 1 depicts a system comprising of an un-provisioned device connected to a provisioning device, according to embodiments as disclosed herein;

FIG. 2 is a sequence diagram depicting the process of provisioning an un-provisioned device, according to embodiments as disclosed herein;

FIG. 3 depicts the un-provisioned device, according to embodiments as disclosed herein;

FIG. 4 depicts the provisioning device, according to embodiments as disclosed herein; and

FIGS. 5a, 5b, and 5c are sequence diagrams depicting example scenarios of provisioning an un-provisioned device, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

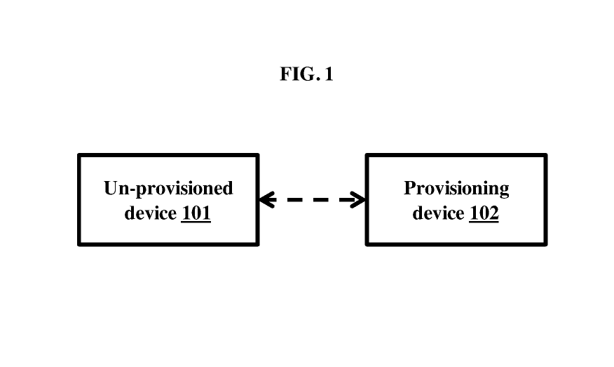

The embodiments herein provide methods and systems for provisioning headless devices. Referring now to the drawings, and more particularly to FIGS. 1 through 5, where similar reference characters denote corresponding features consistently throughout the figures, there are shown preferred embodiments.

An un-provisioned device as referred to herein is a device that has to be provisioned with necessary credentials, configuration, language packs, information, keys so that it can connect to at least one network. Examples of un-provisioned devices are IoT (Internet of Things)/connected devices, Wi-Fi/network connected cameras, and so on. In an embodiment, the un-provisioned device can be a headless device. A headless device is a device that operates without a display, graphical user interface (GUI) or peripheral devices, such as keyboard, mouse, and so on.

Language packs can comprise of a set of pre-programmed voice instructions, which enable the device to communicate instructions for various device operations (such as device is in provisioning mode, ready for provisioning, setup instructions, operation/setup success, and so on). The language packs can be created and customized by an authorized user and/or entity. The customized language pack comprises of user recorded or selected collection of voice instructions for various device operations, instead of pre-recorded voice instructions. Pre-recorded voice instructions can be provided by a vendor of the device. The language pack (customized or pre-recorded) can be sent to the device before provisioning, right after provisioning or at any time.

FIG. 1 depicts a system comprising of an un-provisioned device connected to a provisioning device. The un-provisioned device 101 can communicate with the provisioning device 102 using a suitable communication means such as a wired and/or wireless means. The provisioning device 102 can be at least one a mobile phone, smart phone, tablet, computer, wearable communication means, a dedicated device, and so on. The provisioning device 102 can comprise of an application that facilitates provisioning of the un-provisioned device 101. The application can enable the provisioning device 102 to interact with the user and other entities (if required). The provisioning device 102 can access information such as device details, device key(s), permissions, and so on that are used during provisioning processes. This information can be stored on the provisioning device 102, or in a location that the provisioning device 102 can access, such as a server, a database, the Cloud, and so on.

The un-provisioned device 101 can enter provisioning mode, on receiving an input from the user. The un-provisioned device 101 and the provisioning device 102 can exchange information and prepare themselves for provisioning the un-provisioned device 101. The un-provisioned device 101 can then generate a SetupKey and communicate the SetupKey to the provisioning device 102 by at least one of vocalizing the SetupKey through a speaker, displaying the SetupKey (as is or in a coded format such as a QR (Quick Response) code) on a display present on the un-provisioned device 101. The provisioning device 102 can receive the SetupKey, either in the form of an input by the user, by scanning, or using voice recognition means. The provisioning device 102 can then establish a secure connection with the un-provisioned device 101, using the SetupKey. The provisioning device 102 can then provision the un-provisioned device 101 with parameters and/or settings, which will enable the un-provisioned device 101 to perform communications. The un-provisioned device 101 further logs the status of various provisioning related tasks in at least one of a live manner, at pre-defined intervals, or on pre-defined event(s) occurring.

In an embodiment herein, the un-provisioned device 101 can be connected to multiple provisioning devices 102 simultaneously. In an embodiment herein, the provisioning device 102 can be connected to multiple un-provisioned devices 101 simultaneously.

In an embodiment herein, the provisioning device 102 may communicate with a server. The server can provide information to the provisioning device 102, which is required by the provisioning device 102 and/or the un-provisioned device 101 during the provisioning process.

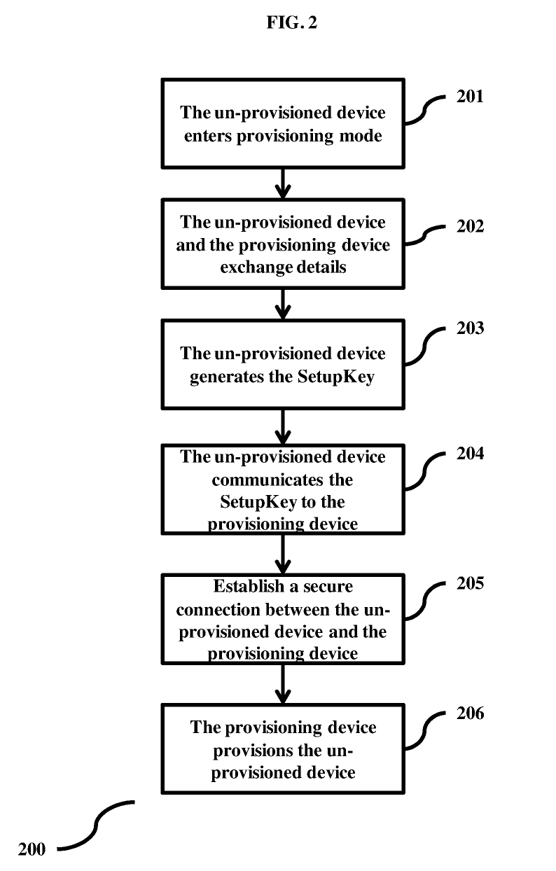

FIG. 2 is a sequence diagram depicting the process of provisioning an un-provisioned device. The provisioning device 102 can be initiated for provisioning. The provisioning device 102 can be initiated by initiating an application on the provisioning device 102. At step 201, the un-provisioned device 101 enters provisioning mode. The un-provisioned device 101 can enter the provisioning mode automatically. The un-provisioned device 101 can enter the provisioning mode, on receiving a pre-defined input from the user. The pre-defined input can be at least one of pressing at least one key/button/switch, providing at least one voice input (which can be a pre-assigned phrase), or any other equivalent means. At step 202, the un-provisioned device 101 and the provisioning device 102 exchange details to prepare for provisioning the un-provisioned device 101. The un-provisioned device 101 can make itself visible by sending relevant broadcast messages over a communication bearer (such as Wi-Fi, Bluetooth, or any other equivalent means). For example, the un-provisioned device 101 may broadcast its MAC (Media Access Controller) identifier prefixed/suffixed with a string (such as Camera—a4d18cd6d606) over a bearer such as Wi-Fi, Bluetooth, Ethernet or any other suitable means and the provisioning device 102 can recognize the broadcast from the un-provisioned device 101. The un-provisioned device 101 and the provisioning device 102 can use a pre-configured communication means. The provisioning device 102 checks if the un-provisioned device 101 supports more than one provisioning method (such as voice based provisioning, server based provisioning. NFC (Near Field Communication) based provisioning. Wi-Fi-WPS (Wi-Fi Protected Setup) provisioning, or any other equivalent means). If the un-provisioned device 101 supports only one method, the provisioning device 102 uses the supported provisioning method. If the un-provisioning device 102 supports multiple provisioning methods, the un-provisioned device 101 and the provisioning device 102 exchanges information related to the supported provisioning methods with each other and the provisioning device 102 determines a provisioning method to be used for provisioning the un-provisioned device 101. The provisioning method can be determined based on inputs provided by the user. The provisioning method can be determined in an automatic manner, without any inputs and/or confirmation from the user.

At step 203, the un-provisioned device 101 generates the SetupKey (which can be an alpha-numeric string). The un-provisioned device 101 can first generate a non-repeating random value of arbitrary size n. The un-provisioned device 101 Base64 encodes the generated random value to generate the SetupKey.

At step 204, the un-provisioned device 101 communicates the SetupKey to the provisioning device 102. In an embodiment herein, the un-provisioned device 101 can vocalize the SetupKey using a speaker present in the un-provisioned device 101. The un-provisioned device 101 can use at least one standard phrase to indicate start or end of the SetupKey. For example, the un-provisioned device 101 can start the vocalization with voice phrase “key start”, a gap for a pre-defined time period, vocalizes the SetupKey, a gap for a pre-defined time period and end the vocalization with the voice phrase “key end”. On the un-provisioned device 101 vocalizing the SetupKey, the provisioning device 102 can capture the sound using a suitable means such as microphone. The provisioning device 102 can perform voice recognition means to determine the SetupKey, wherein the voice recognition means can be present locally on the provisioning device 102 or present remotely in a server that can be accessed by the provisioning device 102 (as and when required). If the provisioning device 102 uses a remote voice recognition means, the communication between the provisioning device 102 and a voice recognition server will be over secure channel and voice recognition service does not store sensitive data (such as SetupKey) or associated voice. The provisioning device 102 can then confirm the SetupKey from the user. The provisioning device 102 can confirm the SetupKey from the user by displaying the determined SetupKey to the user and asking the user for confirmation. The provisioning device 102 can enable the user to edit the determined SetupKey, if required. In an embodiment herein, the un-provisioned device 101 can display the SetupKey using a display present on the un-provisioned device 101. The user can then manually provide the SetupKey to the provisioning device 102. In an embodiment herein, the un-provisioned device 101 can display the SetupKey in the form of a code (such as QR (Quick Response) code). The user can scan the displayed code using the provisioning device 102. The provisioning device 102 can determine the SetupKey from the scanned code. In an embodiment herein, the un-provisioned device 101 can communicate the SetupKey in the form of touch tones (DTMF (Dual Touch Multi-Frequency) tones). The provisioning device 102 can capture the tones and determine the SetupKey from the captures tones. In an embodiment herein, the user can press a pre-defined input to repeat the SetupKey. The pre-defined input can be at least one of pressing at least one key/button/switch, providing at least one voice input (which can be a pre-assigned phrase), or any other equivalent means.

In step 205, the provisioning device 102 can use the SetupKey as a base to establish a secure connection between the un-provisioned device 101 and the provisioning device 102. For example, if the un-provisioned device 101 supports Wi-Fi (and can act as Wi-Fi Access Point), the provisioning device 102 can use the SetupKey as Wi-Fi WPA password and connect to the un-provisioned device 101. Alternately, the provisioning device 102 and the un-provisioned device 101, to protect confidentiality and integrity of sensitive messages exchanged between them, can use the SetupKey. For example, the provisioning device 102 may use the SetupKey to encrypt sensitive information such as home Wi-Fi password, key/token sent to un-provisioned device, and so on. In step 206, the provisioning device 102 provisions language setting, customized language pack on the un-provisioned device 101 using the secure connection. The provisioning device 102 may also provision other parameters/settings on un-provisioned device.

In an embodiment herein, the un-provisioned device 101 can log status of various activities involved in the provisioning process. The un-provisioned device 101 can log the status in a local memory/storage location. The un-provisioned device 101 can log the status in a remote location such as a database, file server, data server, the Cloud, and so on.

In an embodiment herein, the un-provisioned device 101 can communicate status of the provisioning to at least one entity, such as the user, an administrator, a server or an application. The un-provisioned device 101 can retain status of last n provisioning operations performed by user. The un-provisioned device 101 can communicate status of provisioning in language set by the user/provisioning device during the device provisioning process.

In an embodiment herein, if there is a failure in connectivity between the un-provisioned device 101 and the provisioning device 102 during the provisioning process, the un-provisioned device 101 can reinitiate the provisioning process. In an embodiment, the un-provisioned device 101 can reinitiate the provisioning process from the point that the connectivity failed. In an embodiment, the un-provisioned device 101 can initiate the provisioning process from the start of the provisioning process. In an embodiment herein, the un-provisioned device 101 can inform the user of the initiation using a suitable interface such as the display (by displaying a pre-defined phrase), microphone (by vocalizing a pre-defined and pre-recorded phrase) or any other equivalent means.

In an embodiment herein, the un-provisioned device 101 can comprise of at least one user account. In an embodiment herein, the un-provisioned device 101 can require provisioning process to be performed separately for each account. In an embodiment herein, the un-provisioned device 101 can have a common provisioning process for all the accounts.

The un-provisioned device 101 and the provisioning device 102 can exchange data using at least one of IP (Internet Protocol), UDP (User Datagram Protocol), TCP (Transfer Control Protocol), HTTP (HyperText Transfer Protocol), CoAP (Constrained Application Protocol), or any other equivalent means. Before transmission, the data can be encoding as at least one of json (Javascript Object Notation), XML (Extensible Markup Language) or any other suitable standard/proprietary format. If the bearer has payload limitation, the un-provisioned device 101 and the provisioning device 102 can use fragmentation and reassembly to send payloads that are larger than payload that can be sent over a bearer. Implementation may use similar to fragmentation and reassembly approach used by DTLS (Datagram Transport Layer Security, RFC 6347) or other standard/proprietary means.

The various actions in method 200 may be performed in the order presented, in a different order or simultaneously. Further, in some embodiments, some actions listed in FIG. 2 may be omitted.

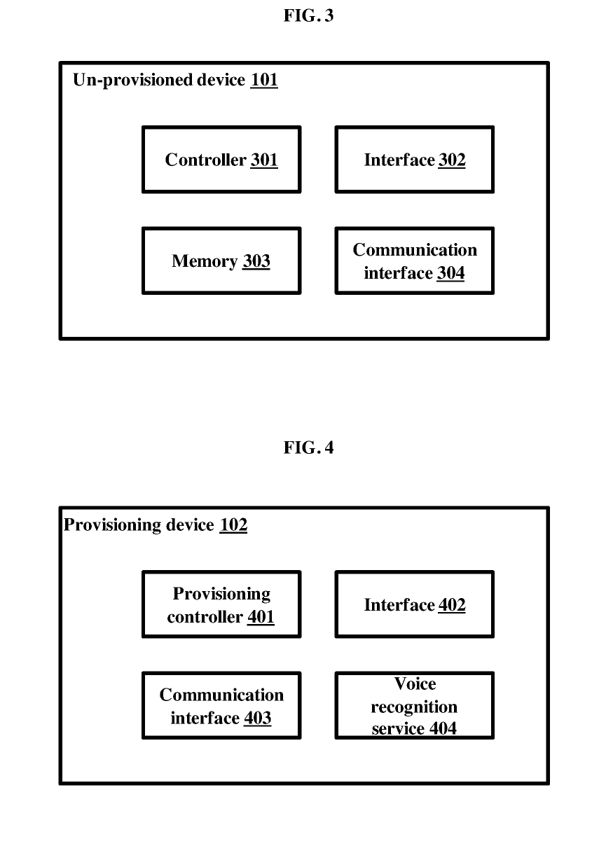

FIG. 3 depicts the un-provisioned device. The un-provisioned device 101, as depicted, comprises of a controller 301, at least one interface 302, a memory 303, and at least one communication interface 304. The interface 302 can be at least one of a display, a speaker, at least one switch/button/toggle, and so on. In an embodiment herein, the un-provisioned device need not comprise of a memory 303. In an embodiment, the memory 303 can be present locally. In an embodiment, the memory 303 can be present remotely, and can be at least one of a server, a file server, a data server, the Cloud, and so on. The communication interface 304 can use at least one of wired and/or wireless means for communication (such as Wi-Fi, Bluetooth, Bluetooth low energy and so on).

The controller 301 can enter provisioning mode, either automatically or on receiving a pre-defined input from the user using the interface 302. The controller 301 can exchange details with the provisioning device 102 to prepare for provisioning the un-provisioned device 101. The controller 301 can make itself visible by sending relevant broadcast messages over the communication interface 304. The controller 301 can further determine a provisioning method to be used for provisioning the un-provisioned device 101, along with the provisioning device 102. The controller 301 can determine the provisioning method based on inputs provided by the user. The controller 301 can determine the provisioning method in an automatic manner, without any inputs and/or confirmation from the user.

The controller 301 can generate the SetupKey. The controller 301 can first generate a non-repeating random value of arbitrary size n. The controller 301 can Base64 encode the generated random value to generate the SetupKey. The controller 301 then communicates the SetupKey to the provisioning device 102 using at least one of the interface 302. In an embodiment herein, the controller 301 can vocalize the SetupKey using a speaker. In an embodiment herein, the controller 301 can display the SetupKey on a display. In an embodiment herein, the controller 301 can convert the SetupKey into a code and display the code on the display. The controller 301 can enable the provisioning device 102 to configure language setting, customized language pack on the un-provisioned device 101. The controller 301 can also enable the provisioning device 102 to configure other parameters/settings on un-provisioned device.

In an embodiment herein, the controller 301 can log status of various activities performed in the provisioning process. The controller 301 can log the status in the memory 303.

In an embodiment herein, the controller 301 can communicate status of the provisioning to at least one entity, such as the user, an administrator, a server or an application. The controller 301 can retain status of last n provisioning operations performed by user. The controller 301 can communicate status of provisioning in language set by user/provisioning device during the device provisioning process.

FIG. 4 depicts the provisioning device. The provisioning device 102, as depicted, comprises of a provisioning controller 401, at least one interface 402, and at least one communication interface 403. The interface 402 can be at least one of a display, a speaker, a keyboard, and so on. The communication interface 403 can use at least one of wired and/or wireless means for communication (such as Wi-Fi, Bluetooth, cellular, and so on). In an embodiment herein, the provisioning device 102 can comprise of a voice recognition service 404.

The provisioning controller 401 can be initiated for provisioning. The provisioning device 102 can be initiated by initiating an application on the provisioning device 102. At step 202, the provisioning controller 401 and the un-provisioned device 101 exchange details to prepare for provisioning the un-provisioned device 101. The provisioning controller 401 can view the un-provisioned device 101 by checking for relevant broadcast messages over a pre-defined communication means. The provisioning controller 401 determines provisioning method to be used for provisioning the un-provisioned device 101. The provisioning controller 401 receives the SetupKey either directly from the un-provisioned device 101 or the user. In an embodiment herein, the provisioning controller 401 can capture the SetupKey vocalized by the un-provisioned device 101 using a microphone. The provisioning controller 401 can then determine the SetupKey using the voice recognition means 404 or an external voice recognition means. On determining the SetupKey, the provisioning controller 401 can confirm the SetupKey with the user. In an embodiment herein, the user can input the SetupKey. In an embodiment herein, the provisioning controller 401 can receive the SetupKey in the form of a code scanned by the interface 402. The provisioning controller 401 can determine the SetupKey from the scanned code, either by itself or using another module (which may be present internal to the provisioning device 102 or external to the provisioning device 102).

The provisioning controller 401 uses the SetupKey as a base to establish a secure connection between the un-provisioned device 101 and the provisioning device 102. Alternately, the provisioning controller 401 and the un-provisioned device 101, to protect confidentiality and integrity of sensitive messages exchanged between them, can use the SetupKey. The provisioning controller 401 can configure language setting, customized language pack on the un-provisioned device 101. The provisioning controller 401 may also configure other parameters/settings on the un-provisioned device 101.

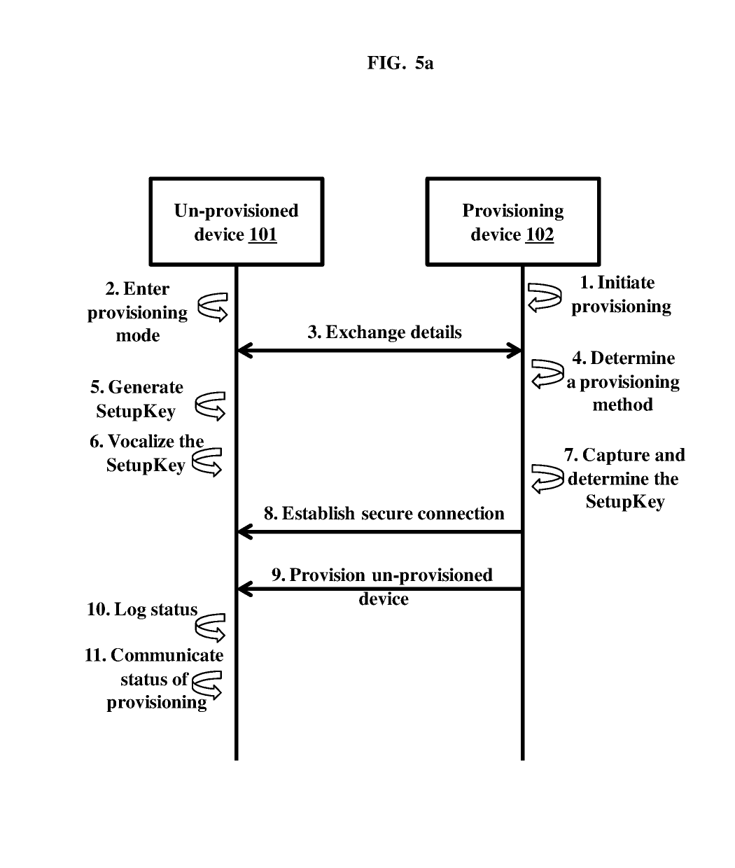

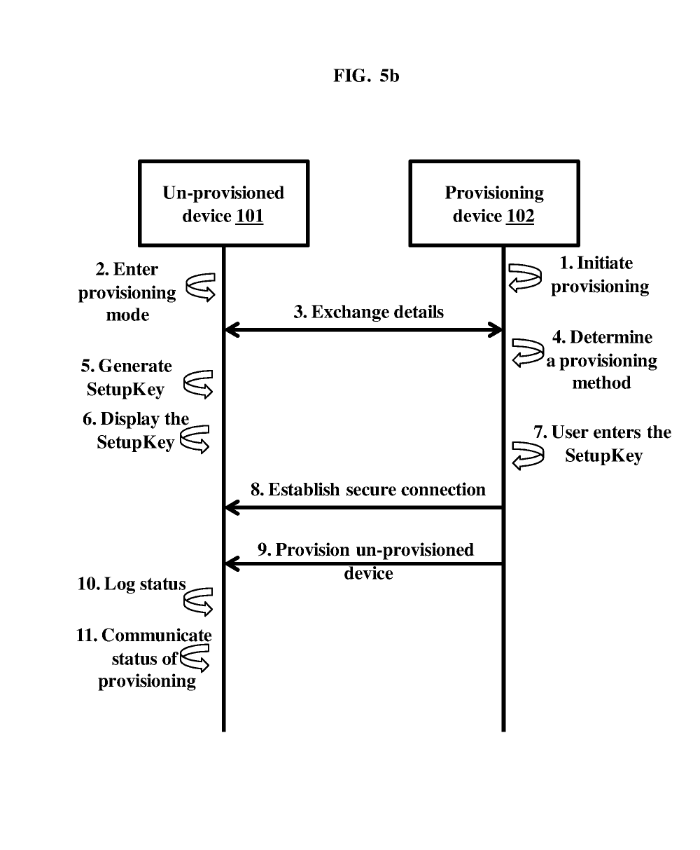

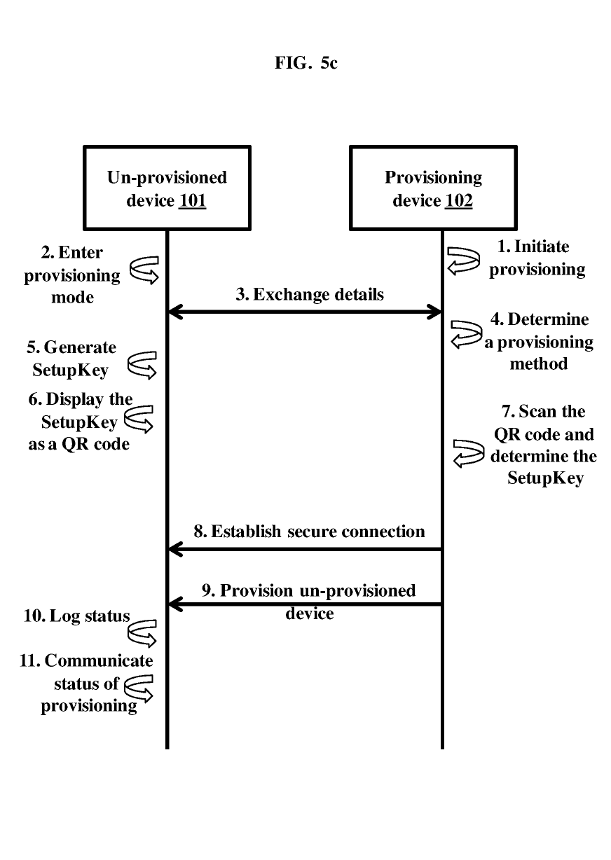

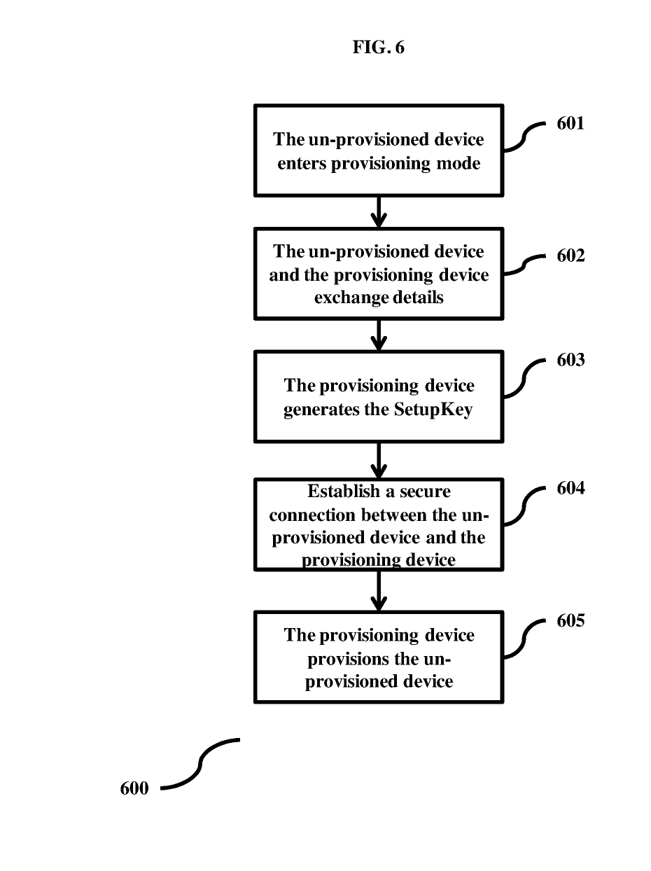

FIGS. 5a, 5b, and 5c are sequence diagrams depicting example scenarios of provisioning an un-provisioned device. In step 1, the provisioning device 102 is initiated for provisioning. The provisioning device 102 can be initiated by initiating an application on the provisioning device 102. In step 2, the un-provisioned device 101 enters provisioning mode. The un-provisioned device 101 can enter the provisioning mode automatically. The un-provisioned device 101 can enter the provisioning mode, on receiving a pre-defined input from the user. At step 3, the un-provisioned device 101 and the provisioning device 102 exchange details to prepare for provisioning the un-provisioned device 101. In step 4, the provisioning device 101 determines the provisioning method to be used. If the un-provisioned device 101 supports only one method, the provisioning device 102 uses the supported provisioning method. If the un-provisioning device 102 supports multiple provisioning methods, the un-provisioned device 101 and the provisioning device 102 exchanges information related to the supported provisioning methods with each other and provisioning device 102 determines a provisioning method to be used for provisioning the un-provisioned device 101. The provisioning method can be determined based on inputs provided by the user. The provisioning method can be determined in an automatic manner, without any inputs and/or confirmation from the user. In step 5, the un-provisioned device 101 generates the SetupKey. The un-provisioned device 101 can first generate a non-repeating random value of arbitrary size n. The un-provisioned device 101 Base64 encodes the generated random value to generate the SetupKey.

In step 6 (referring to FIG. 5a), the un-provisioned device 101 vocalizes the SetupKey using the speaker present in the un-provisioned device 101. In step 7, the provisioning device 102 captures the sound using a suitable means such as microphone and determines the SetupKey using voice recognition means.

In step 6 (referring to FIG. 5b), the un-provisioned device 101 displays the SetupKey using the display present on the un-provisioned device 101. In step 7, the user manually provides the SetupKey to the provisioning device 102.

In step 6 (referring to FIG. 5c), the un-provisioned device 101 displays the SetupKey in the form of a QR code. In step 7, the provisioning device 102 scans the displayed code and determines the SetupKey from the scanned code.

In step 8, the provisioning device 102 uses the SetupKey as a base to establish a secure connection between the un-provisioned device 101 and the provisioning device 102. In step 9, the provisioning device 102 configures language setting, customized or pre-recorded language pack on the un-provisioned device 101. The provisioning device 102 may also configure other parameters/settings on un-provisioned device. In step 10, the un-provisioned device 101 logs status of the provisioning process. In step 11, the un-provisioned device 101 communicates status of the provisioning to at least one entity, such as the user, an administrator, a server or an application. The un-provisioned device 101 can retain status of last n provisioning operations performed by user. The un-provisioned device 101 can communicate status of provisioning in language set by the user/provisioning device during the device provisioning process.

FIG. 6 is a sequence diagram depicting the process of provisioning an un-provisioned device. The provisioning device 102 can be initiated for provisioning. The provisioning device 102 can be initiated by initiating an application on the provisioning device 102. At step 601, the un-provisioned device 101 enters provisioning mode. At step 602, the un-provisioned device 101 and the provisioning device 102 exchange details to prepare for provisioning the un-provisioned device 101. At step 603, the provisioning device 102 generates the SetupKey (which can be an alpha-numeric string). The provisioning device 102 can first generate a non-repeating random value of arbitrary size n. The provisioning device 102 Base64 encodes the generated random value to generate the SetupKey. In step 604, the provisioning device 102 can use the SetupKey as a base to establish a secure connection between the un-provisioned device 101 and the provisioning device 102. Alternately, the provisioning device 102 and the un-provisioned device 101, to protect confidentiality and integrity of sensitive messages exchanged between them, can use the SetupKey. For example, the provisioning device 102 may use the SetupKey to encrypt sensitive information such as home Wi-Fi password, key/token sent to un-provisioned device, and so on. In step 605, the provisioning device 102 provisions language setting, language pack on the un-provisioned device 101 using the secure connection. The provisioning device 102 may also provision other parameters/settings on un-provisioned device. The various actions in method 600 may be performed in the order presented, in a different order or simultaneously. Further, in some embodiments, some actions listed in FIG. 6 may be omitted.

Embodiments herein can work on un-provisioned devices that have connectivity and are constrained in terms of hardware capabilities (such as processing power, storage, and so on). The un-provisioned device need not have display, speaker, microphone, keyboard, and so on. Further, the un-provisioned device need not have capability to perform public key operations or have capability to run secure transport using protocols like TLS (Transport Layer Security) or any other equivalent means.

Embodiments herein do not require the user to manage PIN (Personal Identification Number)/QR code printed on the device package/device for the lifetime of the device.

According to embodiments as disclosed herein, the SetupKey keeps changing every time the device is provisioned. Even if the SetupKey is leaked (for example, post provisioning), it does not cause harm. This is secure and user friendly compared to PIN or QR code printed on the product package and/or the product.

The embodiments disclosed herein can be implemented through at least one software program running on at least one hardware device and performing network management functions to control the network elements. The network elements shown in FIG. 1 include blocks, which can be at least one of a hardware device, or a combination of hardware device and software module.

The embodiment disclosed herein describes provide methods and systems for provisioning headless devices. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high-speed integrated circuit Hardware Description Language (VHDL) another programming language, or implemented by one or more VHDL or several software modules being executed on at least one hardware device. The hardware device can be any kind of portable device that can be programmed. The device may also include means, which could be e.g. hardware means like e.g. an ASIC, or a combination of hardware, and software means, e.g. an ASIC and an FPGA, or at least one microprocessor and at least one memory with software modules located therein. The method embodiments described herein could be implemented partly in hardware and partly in software. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for provisioning an un-provisioned device, the method comprising
generating a SetupKey by one of the un-provisioned device, and a provisioning device; establishing a secure connection between the provisioning device and the un-provisioned device by the provisioning device using the SetupKey as a base; and provisioning the un-provisioned device by the provisioning device over the secure connection.

2. The method, as claimed in claim 1, wherein the method further comprises of the un-provisioned device and the provisioning device exchanging details, before generating the SetupKey.

3. The method, as claimed in claim 1, wherein the SetupKey is generated by
generating a non-repeating random value of arbitrary size; and
generating the SetupKey by encoding the random value.

4. The method, as claimed in claim 1, wherein the method further comprises of the un-provisioned device communicating the SetupKey to the provisioning device, on the un-provisioned device generating the SetupKey.

5. The method, as claimed in claim 4, wherein the un-provisioned device communicates the SetupKey to the provisioning device by
vocalizing the SetupKey by the un-provisioned device;
capturing the vocalization by the provisioning device; and
determining the SetupKey from the captured vocalization by the provisioning device using voice recognition.

6. The method, as claimed in claim 4, wherein the un-provisioned device communicates the SetupKey to the provisioning device by
displaying the SetupKey to a user by the un-provisioned device; and
receiving the SetupKey from the user by the provisioning device.

7. The method, as claimed in claim 4, wherein the un-provisioned device communicates the SetupKey to the provisioning device by
converting the SetupKey into a code by the un-provisioned device;
displaying the code by the un-provisioned device;
scanning the displayed code by the provisioning device; and
determining the SetupKey from the scanned code by the provisioning device.

8. The method, as claimed in claim 4, wherein the un-provisioned device communicates the SetupKey to the provisioning device by
communicating the SetupKey as touch tones by the un-provisioned device;
capturing the touch tones by the provisioning device; and
determining the SetupKey from the captured touch tones by the provisioning device.

9. The method, as claimed in claim 1, wherein the method further comprises of the un-provisioned device logging status of at least one activity performed during provisioning.

10. The method, as claimed in claim 1, wherein the method further comprises of the un-provisioned device communicating status of the provisioning to at least one entity.

11. The method, as claimed in claim 1, wherein the method further comprises of the un-provisioned device re-initiating provisioning process from beginning, if there is a failure in connectivity between the un-provisioned device and the provisioning device.

12. The method, as claimed in claim 1, wherein the method further comprises of the un-provisioned device initiating provisioning process from a point from where connectivity failed, if there is a failure in connectivity between the un-provisioned device and the provisioning device.

13. The method, as claimed in claim 1, wherein the method further comprises of the un-provisioned device managing a plurality of user accounts on the un-provisioned device, wherein each of the user accounts has to be provisioned separately.

14. The method, as claimed in claim 1, wherein the method further comprises of the un-provisioned device managing a plurality of user accounts on the un-provisioned device, wherein each of the user accounts is provisioned together.

15. A system for provisioning an un-provisioned device, the system comprising of a provisioning device, the system configured for
generating a SetupKey by one of the un-provisioned device and the provisioning device;
establishing a secure connection between the provisioning device and the un-provisioned device by the provisioning device using the SetupKey as a base; and
provisioning the un-provisioned device by the provisioning device over the secure connection.

16. The system, as claimed in claim 15, wherein the un-provisioned device and the provisioning device are configured to exchange details, before generating the SetupKey.

17. The system, as claimed in claim 15, wherein the system is configured to generate the SetupKey by
generating a non-repeating random value of arbitrary size; and
generating the SetupKey by encoding the random value.

18. The system, as claimed in claim 15, wherein the un-provisioned device is further configured for communicating the SetupKey to the provisioning device, on the un-provisioned device generating the SetupKey.

19. The system, as claimed in claim 18, wherein the system is configured for enabling the un-provisioned device to communicate the SetupKey to the provisioning device by
vocalizing the SetupKey by the un-provisioned device;
capturing the vocalization by the provisioning device; and
determining the SetupKey from the captured vocalization by the provisioning device using voice recognition.

20. The system, as claimed in claim 18, wherein the system is configured for enabling the un-provisioned device to communicate the SetupKey to the provisioning device by
displaying the SetupKey to a user by the un-provisioned device; and
receiving the SetupKey from the user by the provisioning device.

21. The system, as claimed in claim 18, wherein the system is configured for enabling the un-provisioned device to communicate the SetupKey to the provisioning device by
converting the SetupKey into a code by the un-provisioned device;
displaying the code by the un-provisioned device;
scanning the displayed code by the provisioning device; and
determining the SetupKey from the scanned code by the provisioning device.

22. The system, as claimed in claim 18, wherein the system is configured for enabling the un-provisioned device to communicate the SetupKey to the provisioning device by
communicating the SetupKey as touch tones by the un-provisioned device;
capturing the touch tones by the provisioning device; and
determining the SetupKey from the captured touch tones by the provisioning device.

23. The system, as claimed in claim 15, wherein the un-provisioned device is configured for logging status of at least one activity performed during provisioning.

24. The system, as claimed in claim 15, wherein the un-provisioned device is configured for communicating status of the provisioning to at least one entity.

25. The system, as claimed in claim 15, wherein the un-provisioned device is configured for re-initiating provisioning process from beginning, if there is a failure in connectivity between the un-provisioned device and the provisioning device.

26. The system, as claimed in claim 15, wherein the un-provisioned device is configured for initiating provisioning process from a point from where connectivity failed, if there is a failure in connectivity between the un-provisioned device and the provisioning device.

27. The system, as claimed in claim 15, wherein the un-provisioned device is configured for managing a plurality of user accounts on the un-provisioned device, wherein each of the user accounts has to be provisioned separately.

28. The system, as claimed in claim 15, wherein the un-provisioned device is configured for managing a plurality of user accounts on the un-provisioned device, wherein each of the user accounts is provisioned together.

29. A device configured for
generating a SetupKey, on the device entering provisioning mode;
communicating the generated SetupKey to a provisioning device, wherein the provisioning device establishes a secure connection between the provisioning device and the device using the SetupKey as a base; and
being provisioned by the provisioning device over the secure connection.

30. The device, as claimed in claim 29, wherein the device is configured for exchanging details with the provisioning device, before the un-provisioned device generates the SetupKey.

31. The device, as claimed in claim 29, wherein the device is configured for generating the SetupKey by
generating a non-repeating random value of arbitrary size; and
generating the SetupKey by encoding the random value.

32. The device, as claimed in claim 29, wherein the device is configured for communicating the SetupKey by at least one of
vocalizing the SetupKey;
displaying the SetupKey; and
communicating the SetupKey as touch tones.

33. The device, as claimed in claim 29, wherein the device is configured for communicating the SetupKey by at least one of
converting the SetupKey into a code; and
displaying the code.

34. The device, as claimed in claim 29, wherein the device is configured for logging status of at least one activity performed during provisioning.

35. The device, as claimed in claim 29, wherein the device is configured for communicating status of the provisioning to at least one entity.

36. The device, as claimed in claim 29, wherein the device is configured for re-initiating provisioning process from beginning, if there is a failure in connectivity between the un-provisioned device and the provisioning device.

37. The device, as claimed in claim 29, wherein the device is configured for initiating provisioning process from a point from where connectivity failed, if there is a failure in connectivity between the un-provisioned device and the provisioning device.

38. The device, as claimed in claim 29, wherein the device is configured for managing a plurality of user accounts on the un-provisioned device, wherein each of the user accounts has to be provisioned separately.

39. The device, as claimed in claim 29, wherein the device is configured for managing a plurality of user accounts on the un-provisioned device, wherein each of the user accounts is provisioned together.
